(19) United States
(12) Patent Application Publication
(10) Pub. No.: US 2024/0283263 A1
(43) Pub. Date: Aug. 22, 2024

(54) ROBOT ASSEMBLY

(71) Applicant: Beijing Youzhuju Network Technology Co., Ltd., Beijing (CN)

(72) Inventors: Yunfei LIU, Beijing (CN); Huaqing SUN, Beijing (CN)

(21) Appl. No.: 18/568,573

(22) PCT Filed: Oct. 12, 2022
(86) PCT No.: PCT/CN2022/124783

§ 371 Date: Dec. 8, 2023

(30) Foreign Application Priority Data
Dec. 21, 2021 (CN) 202111574367.0

(51) Int. Cl. H02J 7/00; H01R 13/22; H01R 13/631

(52) U.S. Cl. CPC H02J 7/0042; H01R 13/22; H01R 13/631

(57) ABSTRACT

Disclosed is a robot assembly, including: a robot body and a charging pile, wherein a chassis of the robot body is provided with a positioning groove and a guide groove, a first positive electrode contact and a first negative electrode contact are arranged in the positioning groove, the charging pile is provided with a contact seat selectively matching the positioning groove, and the contact seat is provided with a second positive electrode contact and a second negative electrode contact; and the guide groove has a larger cross-sectional area than the positioning groove, the contact seat enters the positioning groove under the guide action of the guide groove, so that the first positive electrode contact makes contact with the second positive electrode contact, and the first negative electrode contact makes contact with the second negative electrode contact.

The present application claims the priority of Chinese patent application with the application number of 202111574367.0, entitled as “Robot Assembly”, and filed on Dec. 21, 2021, and the entire contents of the application are incorporated into the present application by reference.

### TECHNICAL FIELD

The present application relates to a technical field of robot charging equipment, in particular to a robot assembly.

### BACKGROUND

Related intelligent robot can automatically find their way through navigation to charge, but the charging contacts of robot are relatively small, and the charging posture of robots can't be completely accurate. Navigation used for path finding can't make the robot and the charging pile fit accurately, and the charging failure rate of robot is high. Therefore, the current charging solutions all need additional auxiliary positioning measures to help robots contact the contacts of charging piles, which leads to an increase in the manufacturing cost of robots.

### SUMMARY

The present disclosure aims at solving at least one of the technical problems existing in the related art. Therefore, it is an object of the present disclosure to propose a robot assembly, which can improve the success rate of robot automatic charging, and has low manufacturing cost without additional auxiliary positioning measures.

The robot assembly according an embodiment of the present disclosure includes: a robot body, a chassis of the robot body is provided with a positioning groove and a guide groove, and a first positive contact and a first negative contact are arranged in the positioning groove; a charging pile, the charging pile is provided with a contact seat selectively matched with the positioning groove, and a second positive contact and a second negative contact are arranged on the contact seat; a cross-sectional area of the guide groove is larger than a cross-sectional area of the positioning groove, and the contact seat enters the positioning groove under guidance of the guide groove to make the first positive contact with the second positive contact and make the first negative contact with the second negative contact.

In the robot assembly according to the embodiment of the present disclosure, by providing the guide groove with larger space and volume, the guide groove can guide the contact seat entering the guide groove into the positioning groove, so that the probability of the contact seat entering the positioning groove is improved, the fault tolerance rate of the charging posture of the robot body is improved, and the charging success rate of the robot body is high, so that additional auxiliary charging positioning measures are not needed, and the production and manufacturing cost of the robot assembly is reduced.

In some embodiments, the cross-sectional area of the guide groove gradually decreases in a direction in which the contact seat enters the positioning groove.

In some embodiments, the guide groove includes a first guide wall and a second guide wall which are opposite to each other, and a distance between the first guide wall and the second guide wall gradually decreases in the direction in which the contact seat enters the positioning groove.

In some embodiments, in the direction in which the contact seat enters the positioning groove, a distance between the first guide wall and a center of the positioning groove gradually decreases, and a distance between the second guide wall and the center of the positioning groove gradually decreases.

In some embodiments, the charging pile further includes a charging pile body and a connection rod, at least one of a connection between an end of the connection rod and the charging pile body and a connection between an other end of the connection rod and the contact seat is a rotatable connection.

In some embodiments, the end of the connection rod is hinged with the charging pile body, and the other end of the connection rod is hinged with the contact seat.

In some embodiments, a first reset piece for resetting the contact seat to an initial position is arranged between the end of the connection rod and the contact seat, and a second resetting piece for resetting the connection rod to an initial position is arranged between the other end of the connection rod and the charging pile body.

In some embodiments, the connection rod includes a first connection rod and a second connection rod, an end of the first connection rod is rotatably connected with the contact seat, and an end of the second connection rod is rotatably connected with the charging pile body, a buffer piece is arranged between an other end of the first connection rod and an other end of the second connection rod.

In some embodiments, a thickness of the contact seat is not less than a depth of the positioning groove or the guide groove, and the other end of the connection rod is arranged on a lateral surface of the contact seat away from a bottom wall of the positioning groove or the guide groove.

In some embodiments, a top end of the contact seat is in an arc-shaped structure.

Additional aspects and advantages of the present application will be set forth in the following description, and part will be obvious from the description which follows, or may be learned by practice of the present application.

### BRIEF DESCRIPTION OF DRAWINGS

The above and/or additional aspects and advantages of the present disclosure will be apparent and easily understood from the description of the embodiments taken in conjunction with the following drawings, in which:

FIG. 1 is a schematic view of a first charging position of a robot assembly according to an embodiment of the present disclosure;

FIG. 2 is a schematic view of a second charging position of a robot assembly according to an embodiment of the present disclosure;

FIG. 3 is a schematic view of a third charging position of a robot assembly according to an embodiment of the present disclosure;

FIG. 4 is a structural schematic view of a robot body according to an embodiment of the present disclosure;

FIG. 5 is a schematic structural view of a charging pile according to an embodiment of the present disclosure;

FIG. 6 is a schematic structural view of a charging pile according to a second part of an embodiment of the present disclosure;

Reference numerals: robot assembly 100, robot body 1, chassis 11, positioning groove 2, first positive contact 21, first negative contact 22, guide groove 3, first guide wall 31, second guide wall 32, charging pile 4, charging pile body 40, contact seat 5, second positive contact 51, second negative contact 52, connection rod 6, first connection rod 61, second connection rod 61, buffer piece 63 and position sensor 64.

### DETAILED DESCRIPTION

Hereinafter, embodiments of the present disclosure will be described in detail, examples of the embodiments are illustrated in the accompanying drawings, in which the same or similar reference numerals indicate the same or similar elements or elements having the same or similar functions throughout. The embodiments described below by referring to the drawings are exemplary and are only used to explain the present disclosure, and cannot be understood as limitations of the present disclosure.

In the description of the present disclosure, it should be understood that, the orientation relationship or position relationship indicated by terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial” and “circumferential” are based on the orientation relationship or position relationship shown in the drawings, and are only for the convenience of describing the present disclosure and simplifying the description, and does not indicate or imply that the referred devices or elements must have a specific orientation, be constructed and operated in a specific orientation, so it cannot be understood as a limitation of the present disclosure. In the description of the present disclosure, “a plurality of” refers to two or more.

Hereinafter, a robot assembly 100 according to an embodiment of the present disclosure will be described with reference to FIGS. 1 to 6.

The robot assembly 100 according to the embodiment of the present disclosure includes a robot body 1 and a charging pile 4, a chassis 11 of the robot body 1 is provided with a positioning groove 2 and a guide groove 3, a first positive contact 21 and a first negative contact 22 are arranged in the positioning groove 2, the charging pile 4 is provided with a contact seat 5 selectively matched with the positioning groove 2, and a second positive contact 51 and a second negative contact 52 are arranged on the contact seat 5, cross-sectional area of the guide groove 3 is larger than cross-sectional area of the positioning groove 2, and the contact seat 5 enters the positioning groove 2 under the guidance of the guide groove 3 to make the first positive contact 21 contact with the second positive contact 51 and make the first negative contact 22 contact with the second negative contact 52.

The robot assembly 100 of the embodiment of the present disclosure includes the robot body 1 and the charging pile 4 for charging the robot body 1. It can be understood that the charging pile 4 is directly connected with a main power supply, and the position of the charging pile 4 generally does not change after installation and arrangement, while the robot body 1 works and moves when the power is sufficient, connects with the charging pile 4 for charging after the power is reduced to a set value, and continues to work after the power is sufficient. A structure of the chassis 11 of the robot body 1 is illustrated by FIG. 4 which takes a direction of the robot body 1 in normal operation as a reference system and in a view of the robot body 1 from bottom to up. The chassis 11 of the robot body 1 is provided with a charging place for connecting with the charging pile 4. By arranging the charging place on the chassis 11 of the robot body 1, when the robot is connected with the charging pile 4 for charging, the robot body 1 can shield the charging place, so that people around are not easy to touch charged components, and some pollution such as dust and water is not easy to pollute the charging place, which can improve the safety of the robot body 1.

The robot body 1 is provided with the first positive contact 21 and the first negative contact 22, and the charging pile 4 is provided with the second positive contact 51 and the second negative contact 52. When the first positive contact 21 contacts the second positive contact 51 and the first negative contact 22 contacts the second negative contact 52, the charging pile 4 charges the robot body 1. The first positive contact 21 and the first negative contact 22 are arranged in the positioning groove 2, the second positive contact 51 and the second negative contact 52 are arranged on the contact seat 5. In the case that the contact seat 5 and the positioning groove 2 match with each other, the charging pile 4 can charge the robot body 1, and in the case the contact seat 5 no longer matches with the positioning groove 2 and the contact seat 5 comes out of the positioning groove 2, the charging pile 4 stops charging the robot body 1. When the robot body 1 in the embodiment of the present disclosure is to be charged, the robot body 1 navigates to a vicinity of the charging pile 4 and then moves close to the charging pile 4. As illustrated by FIG. 1, the robot body 1 moves towards the charging pile 4 from front to back, so that the contact seat 5 moves from back to front relative to the robot body 1, and the contact seat 5 moves forward into the positioning groove 2 until the contact seat 5 and the positioning groove 2 match with each other. After the robot body 1 is charged, the robot body 1 moves from back to front, so that the contact seat 5 moves from front to back relative to the robot body 1, and the contact seat 5 comes out of the positioning groove 2.

The chassis 11 of the robot body 1 is further provided with the guide groove 3 connected with the positioning groove 2, and the positioning groove 2 and the guide groove 3 are integrally formed. It can be understood that in the present disclosure, in order to facilitate the structural description of the robot assembly 100, the positioning groove 2 and the guide groove 3 are separated to simplify the description, and there is no indication or suggestion that the positioning groove 2 and the guide groove 3 are of a split structure, and there is no restriction on the structural forms of the positioning groove 2 and the guide groove 3.

It can be understood that both the positioning groove 2 and the contact seat 5 are small in volume, and when the robot body 1 moves relative to the charging pile 4, due to factors such as position deviation, it is easy that the positioning groove 2 and the contact seat 5 are not facing each other but have different angles from each other. By providing the guide groove 3 in the robot assembly 100 of the present disclosure, the contact seat 5 and the positioning groove 2 can match with for charging even when a charging posture of the robot body 1 is inaccurate.

The cross-sectional area of the guide groove 3 is larger than the cross-sectional area of the positioning groove 2. As illustrated by FIGS. 1 and 4, a plane perpendicular to a straight line coincident with a direction in which the contact seat 5 enters the positioning groove 2 is a plane perpendicular to a straight line extending in a front-to-back direction. The cross-sectional area of guide groove 3 cut off by the plane is larger than the cross-sectional area of the positioning groove 2 cut off by the plane. That is to say, in a path of the contact seat 5 entering the positioning groove 2, the contact seat 5 first enters the guide groove 3 with larger space and volume, and then enters the positioning groove 2 with smaller space and volume to match with the positioning groove 2. By providing the guide groove 3 with larger space and volume, contact area between the contact seat 5 and the charging place of the robot can be improved, and the probability of the contact seat 5 entering the guide groove 3 can be improved. Moreover, the guide groove 3 has a guiding function, and the contact seat 5 entering the guide groove 3 can be guided into the positioning groove 2, so that the robot body 1 can be charged even when the charging posture is inaccurate, and the charging success rate of the robot body 1 can be improved. The robot assembly 100 of the embodiment of the present disclosure can guide the contact seat 5 into the positioning groove 2 through the guide groove 3, and it is unnecessary to set additional auxiliary positioning measures, thus reducing the production and manufacturing cost of the robot assembly 100.

According to the robot assembly 100 of the embodiment of the present disclosure, the guide groove 3 with a larger cross-sectional area is arranged on the chassis 11, and the guide groove 3 can guide the contact seat 5 to enter the guide groove 3 into the positioning groove 2, so that the probability of the contact seat 5 entering the positioning groove 2 is improved, the fault tolerance rate of the charging posture of the robot body 1 is improved, and the charging success rate of the robot body 1 is high, so that additional auxiliary charging positioning measures are not needed, and the production and manufacturing cost of the robot assembly 100 is reduced.

In some embodiments, as illustrated by FIG. 4, the cross-sectional area of the guide groove 3 gradually decreases in the direction in which the contact seat 5 enters the positioning groove 2.

As illustrated by FIG. 4, the direction in which the contact seat 5 enters the positioning groove 2 is a direction from back to front, the cross-sectional area of the guide groove 3 cut off by the plane perpendicular to the straight line extending in the front-to-back direction decreases gradually in a back-to-front direction. It can be understood that the above direction is based on the direction illustrated by the attached drawings, which is only for the convenience of describing the present disclosure and simplifying the description, and does not indicate or imply that the robot assembly 100 of the present disclosure must have a specific direction, be constructed and operated in the specific orientation, so it cannot be understood as a limitation of the present disclosure.

The positioning groove 2 is located behind the guide groove 3, and the cross-sectional area of the guide groove 3 facing the outside is the largest, so as to increase a contact area with the contact seat 5. The cross-sectional area of the guide groove 3 gradually decreases in a direction toward the positioning groove 2, so that the contact seat 5 can be guided to the positioning groove 2, so that the contact seat 5 and the positioning groove 2 can match with each other.

In some embodiments, as illustrated by FIG. 4, the guide groove 3 includes a first guide wall 31 and a second guide wall 32 facing each other, and a distance between the first guide wall 31 and the second guide wall 32 gradually decreases in the direction in which the contact seat 5 enters the positioning groove 2.

In some embodiments, the guide groove 3 is opened on the chassis 11 of the robot body 1, and the first guide wall 31, the second guide wall 32 and a bottom wall of the robot body 1 jointly define the guide groove 3, and the distance between the first guide wall 31 and the second guide wall 32 gradually decreases in the back-to-front direction, thereby the cross-sectional area of the guide groove 3 gradually decreases in the back-to-front direction, so that the contact seat 5 can be guided to the positioning groove 2, and the contact seat 5 and the positioning groove 2 can match with each other

Specifically, in the direction in which the contact seat 5 enters the positioning groove 2. a distance between the first guide wall 31 and a center of the positioning groove 2 gradually decreases, and a distance between the second guide wall 32 and the center of the positioning groove 2 gradually decreases.

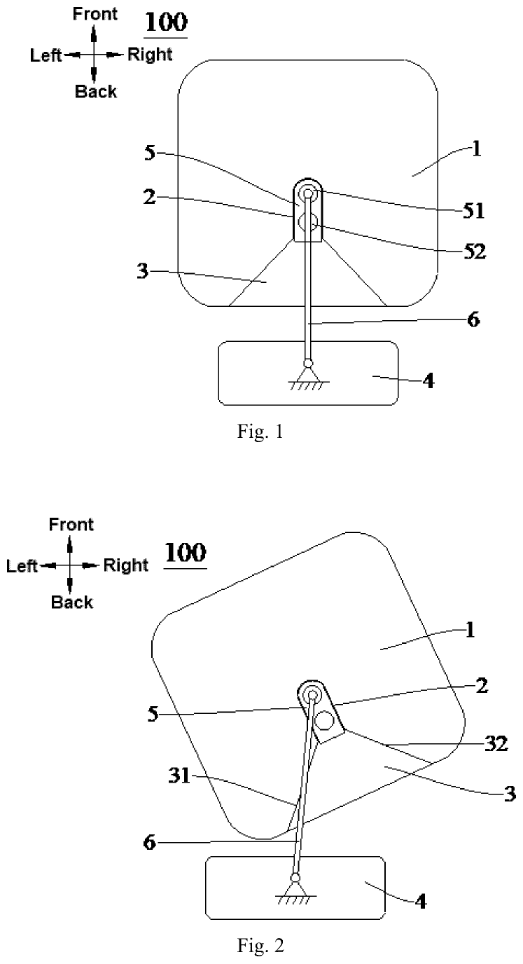

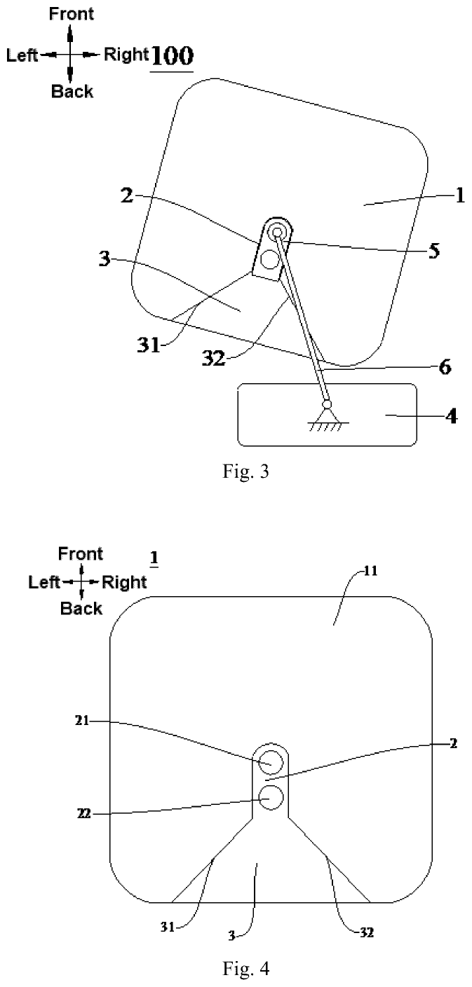

Both the first guide wall 31 and the second guide wall 32 gradually incline toward the center of the positioning groove 2, and both the first guide wall 31 and the second guide wall 32 have a guiding function, which can guide the contact seat 5 toward the positioning groove 2. As illustrated by FIG. 2, in the case the robot body 1 and the charging pile 4 have an angular offset, the robot body 1 moves towards the charging pile 4, and the contact seat 5 first enters the guide groove 3 and contacts with the first guide wall 31, the distance between the first guide wall 31 and the center of the positioning groove 2 gradually decreases, the first guide wall 31 can guide the contact seat 5 toward the positioning groove 2. Similarly, as illustrated by FIG. 3, the second guide wall 32 can also guide the contact seat 5 towards the positioning groove 2.

In some specific embodiments of the present disclosure, the first guide wall 31 and the second guide wall 32 can also be configured in special shapes such as arcs, so as to reduce the friction of the first guide wall 31 and the second guide wall 32 on the contact seat 5 and improve the movement fluency of the contact seat 5.

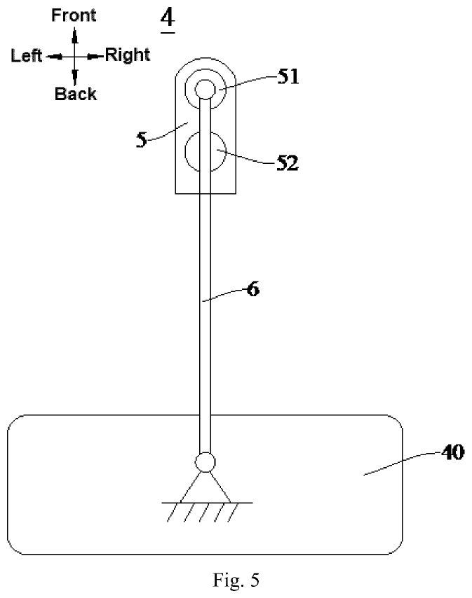

In some embodiments, as illustrated by FIG. 5, the charging pile 4 further includes a charging pile body 40 and a connection rod 6, at least one of the connection between an end of the connection rod 6 and the charging pile body 40 and the connection between the other end of the connection rod 6 and the contact seat 5 is a rotatable connection.

The charging pile body 40 is connected with the main power supply, which is generally a fixed element. The connection rod 6 is arranged on the charging pile body 40 and protrudes from the charging pile body 40, one end of the connection rod 6 is connected with the charging pile body 40, and the other end of the connection rod 6 is connected with the contact seat 5. By arranging the connection rod 6, the contact seat 5 protrudes from the charging pile body 40, which can improve a motion range of the contact seat 5. The contact seat 5 can extend into the guide groove 3 and the positioning groove 2 and match with the positioning groove 2 for charging.

In some embodiments, the connection rod 6 can rotate relative to the charging pile body 40, in other embodiments, the connection rod 6 can rotate relative to the contact seat 5, and in other embodiments, the connection rod 6 can rotate relative to the charging pile body 40 and also rotate relative to the contact seat 5 at the same time. By making both the contact seat 5 and/or the connection rod 6 rotatable, the motion range of the contact seat 5 can be further improved. As illustrated by FIGS. 2 and 3, in the case the robot body 1 and the charging pile 4 have an angular offset, the contact seat 5 or the connection rod 6 also has a corresponding angular offset with respect to the charging pile 4, so that the contact seat 5 can be attached to the positioning groove 2 for charging. In addition, when the contact seat 5 contacts with the first guide wall 31 or the second guide wall 32, the contact seat 5 is driven and guided by the first guide wall 31 or the second guide wall 32, the connection rod 6 is at risk of being damaged by extrusion. The contact seat 5 or the connection rod 6 is designed to be rotatable, and the contact seat 5 or the connection rod 6 can rotate when stressed, so that the service life of the contact seat 5 and the connection rod 6 can be prolonged.

In some embodiments, as illustrated by FIGS. 2 and 5, one end of the connection rod 6 is hinged with the charging pile body 40, and the other end of the connection rod 6 is hinged with the contact seat 5. The connection rod 6 can rotate relative to the charging pile body 40 and also relative to the contact seat 5 at the same time, the connection rod 6 and the contact seat 5 move smoothly which can prolong the service life of the contact seat 5 and the connection rod 6, improve the matching accuracy of the contact seat 5 with the positioning groove 2, and improve the charging success rate of the robot body 1.

In some embodiments, a first reset piece is arranged between the end of the connection rod 6 and the contact seat 5, and a second reset piece is arranged between the other end of the connection rod 6 and the charging pile body 40.

As illustrated by FIG. 5, when the connection rod 6 is in an initial position, the second reset piece is in a normal state, the connection rod 6 extends in the front-to-back direction and is perpendicular to the charging pile body 40, and when the contact seat 5 is in an initial position, the first reset piece is in a normal state, and the contact seat 5 extends in the front-to-back direction and is perpendicular to the charging pile body 40.

When the connection rod 6 and the contact seat 5 are in the initial position, the connection rod 6 and the contact seat 5 are perpendicular to the charging pile body 40. When the robot body 1 is opposite, offset to the left or offset to the right with respect to the charging pile 4, both the connection rod 6 and the contact seat 5 can rotate to adapt to the robot body 1. Compared with other positions, positions where the connection rod 6 and the contact seat 5 are opposite to the charging pile 4 is more convenient and faster to adapt to the robot body 1 at any position. By arranging the first reset piece and the second reset piece, the connection rod 6 and the contact seat 5 can be reset to initial positions after the robot body 1 is charged, so as to prepare for the next charging. By arranging the first reset piece and the second reset piece, the automation effect of the charging pile 4 is improved, and manual operation is not needed, so that it is convenient to use.

In some embodiments of the present disclosure, both the first reset piece and the second reset piece are torsion springs. As illustrated by FIGS. 2 and 5, when the robot assembly 100 is in a second charging position, the contact seat 5 is offset relative to the charging pile body 40, and the connection rod 6 is offset relative to the charging pile 4. The torsion springs is stretched or compressed by force and accumulates elastic potential energy. When the robot body 1 is charged, the torsion springs releases the elastic potential energy to drive the contact seat 5 and the connection rod 6 to reset to the initial position.

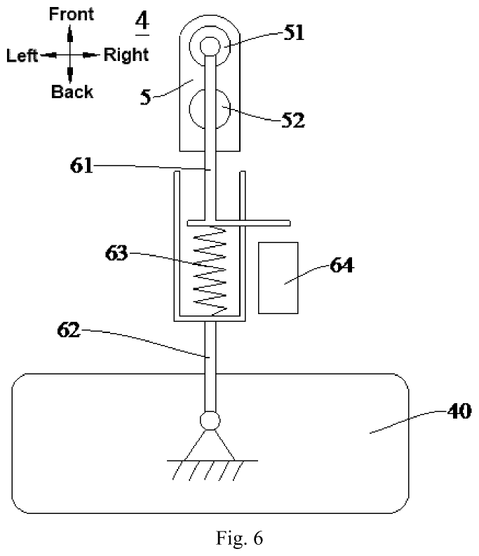

In a second part of embodiment, as illustrated by FIG. 6, the connection rod 6 includes a first connection rod 61 and a second connection rod 62, an end of the first connection rod 61 is rotatably connected with the contact seat 5, and an end of the second connection rod 62 is rotatably connected with the charging pile body 40, and a buffer piece 63 is arranged between the other end of the first connection rod 61 and the other end of the second connection rod 62.

The buffer piece 63 arranged between the first connection rod 61 and the second connection rod 62 can reduce an impact force on the connection rod 6 when the robot body 1 moves towards the charging pile 4 and prolong the service life of the connection rod 6.

Specifically, the buffer piece 63 is a spring. By arranging the spring between the first connection rod 61 and the second connection rod 62, the first connection rod 61 and the second connection rod 62 can rotate relatively, thereby further improving a swing angle of the connection rod 6, further improving the motion range of the contact seat 5 and improving the charging success rate of the robot body 1.

In some embodiments of the second part of the present disclosure, the other end of the second connection rod 62 is further provided with a stop block extending towards the first connection rod 61, and the buffer piece 63 is arranged in an inner space of the stop block, which can limit the buffer piece 63 and prevent the first connection rod 61 from bending under the drive of the buffer piece 63 when it is impacted by the robot body 1.

In some embodiments of the second part of the present disclosure, a position sensor 64 is further arranged between the other end of the first connection rod 61 and the other end of the second connection rod 62, and a contact is arranged at the other end of the first connection rod 61. When the first connection rod 61 moves towards the second connection rod 62 so that the contact contacts with the position sensor 64, the position sensor 64 is triggered, and a control center in the charging pile 4 judges that the robot body 1 has moved in place, and the control center sends an instruction to stop the movement to the robot body 1, which can effectively avoid the situation that the robot body 1 damages the charging pile 4 due to excessive movement.

In some embodiments, the position sensor 64 may be an infrared light switch, a Hall sensor or the like.

In some embodiments, as illustrated by FIGS. 2 and 3, a thickness of the contact seat 5 is not less than a depth of the positioning groove 2 or the guide groove 3, and the other end of the connection rod 6 is arranged on a lateral surface of the contact seat 5 away from a bottom wall of the positioning groove 2 or the guide groove 3. This design can keep the connection rod 6 away from a surface of the chassis of the robot body 1, avoid motion interference with the robot body 1 when the connection rod 6 and the contact seat 5 move relative to the robot body 1, avoid the connection rod 6 from being damaged by extrusion, prolong the service life of the connection rod 6, and improve the movement fluency when charging the robot body 1.

In some embodiments, a top end of the contact seat 5 is in an arc-shaped structure, which can reduce the friction of the first guide wall 31 and the second guide wall 32 on the contact seat 5 and improve the movement fluency of the contact seat 5.

Hereinafter, a charging process of the robot assembly 100 according to the embodiment of the present disclosure at different charging positions will be described with reference to FIGS. 1 to 3.

As illustrated by FIG. 1, when the robot assembly 100 is in a first charging position, the robot body 1 is opposite to the charging pile 4. When the robot body 1 moves towards the charging pile body 40, the contact seat 5 smoothly passes through the guide groove 3 without contacting the first guide wall 31 and the second guide wall 32, and directly enters the positioning groove 2. The contact seat 5 matches with the positioning groove 2 to charge.

As illustrated by FIG. 2, when the robot assembly 100 is in the second charging position, the robot body 1 has a certain angular offset from the charging pile 4 to the left. During the movement of the robot body 1 to the charging pile body 40, the contact seat 5 first contacts with the first guide wall 31, and the connection rod 6 is driven by the first guide wall 31 to rotate to the right, and the contact seat 5 contacts with the first guide wall 31 with an arc-shaped top end. The contact seat 5 slides along the first guide wall 31 toward the positioning groove 2, and the contact seat 5 deflects to the left under the joint action of the positioning groove 2 and the guide groove 3, and enters the positioning groove 2, and the contact seat 5 matches with the positioning groove 2 to charge the robot body 1.

As illustrated by FIG. 3, when the robot assembly 100 is in a third charging position, the robot body 1 has a certain angular offset from the charging pile 4 to the right. During the movement of the robot body 1 to the charging pile body 40, the contact seat 5 first contacts with the second guide wall 32, and the connection rod 6 is driven by the second guide wall 32 to rotate to the left, and the contact seat 5 contacts with the second guide wall 32 with an arc-shaped top end. The contact seat 5 slides along the second guide wall 32 toward the positioning groove 2, and the contact seat 5 deflects to the right under the joint action of the positioning groove 2 and the guide groove 3, and enters the positioning groove 2, and the contact seat 5 matches with the positioning groove 2 to charge the robot body 1.

Other components and operations of the robot assembly 100 according to the embodiment of the present disclosure, such as the charging pile 4 and the control center, are known to ordinary people in the field, and will not be described in detail here.

In the description of this specification, descriptions referring to the terms “one embodiment”, “some embodiments”, “exemplary embodiments”, “examples”, “specific examples” or “some examples” refer to that specific features, structures, materials or characteristics described in connection with this embodiment or example are included in at least one embodiment or example of this application. In this specification, the schematic expressions of the above terms do not necessarily refer to the same embodiment or example. Moreover, the specific features, structures, materials or characteristics described may be combined in any one or more embodiments or examples in a suitable manner.

Although the embodiments of this application have been shown and described, those skilled in the art can understand that many changes, modifications, substitutions and variations can be made to these embodiments without departing from the principles and purposes of this application, and the scope of this application is defined by the claims and their equivalents.

1. A robot assembly, comprising:
a robot body, wherein a chassis of the robot body is provided with a positioning groove and a guide groove, and a first positive contact and a first negative contact are arranged in the positioning groove;
a charging pile, wherein the charging pile is provided with a contact seat selectively matched with the positioning groove, and a second positive contact and a second negative contact are arranged on the contact seat;
wherein a cross-sectional area of the guide groove is larger than a cross-sectional area of the positioning groove, and the contact seat enters the positioning groove under guidance of the guide groove to make the first positive contact with the second positive contact and make the first negative contact with the second negative contact.

2. The robot assembly according to claim 1, wherein the cross-sectional area of the guide groove gradually decreases in a direction in which the contact seat enters the positioning groove.

3. The robot assembly according to claim 2, wherein the guide groove comprises a first guide wall and a second guide wall which are opposite to each other, and a distance between the first guide wall and the second guide wall gradually decreases in the direction in which the contact seat enters the positioning groove.

4. The robot assembly according to claim 3, wherein, in the direction in which the contact seat enters the positioning groove, a distance between the first guide wall and a center of the positioning groove gradually decreases, and a distance between the second guide wall and the center of the positioning groove gradually decreases.

5. The robot assembly according to claim 1, wherein the charging pile further comprises a charging pile body and a connection rod, at least one of a connection between an end of the connection rod and the charging pile body and a connection between an other end of the connection rod and the contact seat is a rotatable connection.

6. The robot assembly according to claim 5, wherein the end of the connection rod is hinged with the charging pile body, and the other end of the connection rod is hinged with the contact seat.

7. The robot assembly according to claim 5, wherein a first reset piece for resetting the contact seat to an initial position is arranged between the end of the connection rod and the contact seat, and a second resetting piece for resetting the connection rod to an initial position is arranged between the other end of the connection rod and the charging pile body.

8. The robot assembly according to claim 5, wherein the connection rod comprises a first connection rod and a second connection rod, an end of the first connection rod is rotatably connected with the contact seat, and an end of the second connection rod is rotatably connected with the charging pile body, a buffer piece is arranged between an other end of the first connection rod and an other end of the second connection rod.

9. The robot assembly according to claim 8, wherein the other end of the second connection rod is further provided with a stop block extending towards the first connection rod, and the buffer piece is arranged in an inner space of the stop block.

10. The robot assembly according to claim 8, wherein a position sensor is further arranged between the other end of the first connection rod and the other end of the second connection rod, and a contact is arranged at the other end of the first connection rod;
when the first connection rod moves towards the second connection rod to make the contact with the position sensor, a control center in the charging pile judges that the robot body has moved in place.

11. The robot assembly according to claim 5, wherein a thickness of the contact seat is not less than a depth of the positioning groove or the guide groove, and the other end of the connection rod is arranged on a lateral surface of the contact seat away from a bottom wall of the positioning groove or the guide groove.

12. The robot assembly according to claim 1, wherein a top end of the contact seat is in an arc-shaped structure.

13. The robot assembly according to claim 1, wherein the positioning groove and the guide groove are integrally formed.

14. The robot assembly according to claim 3, wherein the first guide wall and the second guide wall are configured in arc shapes.

15. The robot assembly according to claim 7, wherein both the first reset piece and the second reset piece are torsion springs.

16. The robot assembly according to claim 10, wherein the position sensor includes an infrared light switch or a Hall sensor.
